(19) United States
(12) Patent Application Publication
(10) Pub. No.: US 2009/0064727 A1
(43) Pub. Date: Mar. 12, 2009

(54) DRIVING APPARATUS FOR WASHING MACHINE

(75) Inventors: Soung Bong Choi, Gyeongsangnam-do (KR); Hung Myong Cho, Gyeongsangnam-do (KR)

Correspondence Address: KED & ASSOCIATES, LLP, P.O. Box 221200, Chantilly, VA, 20153-1200, US

(73) Assignee: LG ELECTRONICS INC., Seoul (KR)

(21) Appl. No.: 11/547,094

(22) PCT Filed: Feb. 1, 2006
(86) PCT No.: PCT/KR2006/000341

§ 371 Date: Nov. 17, 2008

(30) Foreign Application Priority Data
Feb. 1, 2005 (KR) 10-2005-0009063

(51) Int. Cl. D06F 37/30; D06F 37/40; H02K 16/02; H02K 1/18

(52) U.S. Cl. 68/140

(57) ABSTRACT

A driving apparatus for a washing machine is disclosed. The driving apparatus includes a tub containing washing water and provided with a drum rotatably installed therein; a double rotor comprising an outer rotor provided with magnets supported by the inner surface thereof, and an inner rotor installed at the inside of the outer rotor and provided with magnets supported by the outer surface thereof; an internal bearing fixed to the rear surface of the tub for rotatably supporting the inner portion of a drum shaft connecting the drum and the double rotor; an external bearing supporter provided with an external bearing for rotatably supporting the outer end of the drum shaft; and a stator fixed to the rear surface of the external hearing supporter so that the stator is disposed between the outer rotor and the inner rotor, and generating magnetic energy for rotating the double rotor by electrical energy supplied from the outside.

### TECHNICAL FIELD

The present invention relates to a washing machine, and more particularly, to a driving apparatus for a washing machine, in which rotors are installed at both sides of a stator so as to improve torque.

### BACKGROUND ART

Generally, washing machines wash laundry using friction between washing water and the laundry in a drum rotated by driving force of a motor under the condition that a detergent, the washing water, and the laundry are placed into the drum. Here, the drum refers to a washing tub containing the washing water and the laundry, and is applied to all washing machines including a drum-type washing machine or a pulsator-type washing machine.

Further, driving methods of washing machines are divided into an indirect connection-type driving method, in which the driving force of a motor is indirectly transmitted to a drum through a valve wound on a motor pulley and a drum pulley, and a direct connection-type driving method, in which a motor is directly connected to a drum so that the driving force of a motor is directly transmitted to a drum.

In the indirect connection-type driving method, in which the driving force of the motor is not directly transmitted to the drum but is indirectly transmitted to the drum through the valve wound on the motor pulley and the drum pulley, an energy loss is generated during the driving force transmission process and a high degree of noise is generated during a power transmission process. Accordingly, in order to solve the above problems, a washing machine employing a motor directly connected to a drum has been increasingly used.

FIG. 1 is a longitudinal sectional view schematically illustrating the structure of a conventional drum washing machine.

As shown in FIG. 1, the conventional drum washing machine comprises a tub 2 installed in a cabinet 1, and a drum 3 rotatably installed in the central portion of the tub 2.

A motor having a stator 6 and a rotor 5 is installed in the rear of the tub 2. The stator 6 is fixed to the rear wall of the tub 2, and the rotor 5 surrounds the stator 6 and is connected to the drum 3 by a drum shaft 4 passing through the tub 2. Although not shown in the drawings, magnets are disposed on the inner circumferential surface of the rotor 5 such that N and S poles of the magnets are alternated with each other.

A door 7 is installed on the front surface of the cabinet 1, and a gasket 8 is installed between the door 7 and the tub 2. Suspension springs 9a for supporting the tub 2 are installed between the internal upper surface of the cabinet 1 and the external upper surface of the tub 2, and friction dampers 9b for damping the vibration of the tub 2 generated when the washing machine is operated in a drying mode are installed between the internal lower surface of the cabinet 1 and the external lower surface of the tub 2.

A tub supporter (not shown), which has a shape similar to the outer surface of the rear wall of the tub 2 and is fixed to the rear wall of the tub 2, when the stator 6 is fixed to the rear wall of the tub 2, so as to support the load of the stator 6 and to maintain the concentricity of the stator 6, is interposed between the rear wall of the tub 2 and the stator 6.

When power is supplied to the stator 6, the stator 6 functions as an electromagnet. Then, the rotor 5 is rotated by a rotating magnetic field formed between the stator 6 and the magnets formed on the rotor 5, and the rotating force of the rotor 5 is transmitted to the drum 3 through the drum shaft 4.

As the volume of washing machines has increased recently, the output of the motor for rotating the drum 3 has also increased. In order to increase the output of the motor, the rotor 5 and the stator 6 are enlarged, thereby drastically increasing the size and weight of the motor.

Accordingly, the present applicant proposes a washing machine having a double rotor-type motor, which is disclosed in Korean Patent Laid-open Publication No. 2001-0097204 (dated Nov. 8, 2001), so as to increase the output. Here, coils are wound on inner and outer surfaces of a stator, and inner and outer rotors are respectively installed at the inside and outside of the stator such that the inner and outer rotors are spaced from the inner and outer surfaces of the stator by a designated gap.

The above double rotor-type motor generates high output, and thus needs to be more firmly mounted in the washing machine.

### DISCLOSURE OF INVENTION

### Technical Problem

An object of the present invention devised to solve the problem lies on a washing machine with a double rotor-type motor having an improved structure.

### Technical Solution

The object of the present invention can be achieved by providing a driving apparatus for a washing machine comprising a tub containing washing water and provided with a drum rotatably installed therein; a double rotor comprising an outer rotor provided with magnets supported by the inner surface thereof, and an inner rotor installed at the inside of the outer rotor and provided with magnets supported by the outer surface thereof; an internal bearing fixed to the rear surface of the tub for rotatably supporting the inner portion of a drum shaft connecting the drum and the double rotor; an external bearing supporter provided with an external bearing for rotatably supporting the outer end of the drum shaft; and a stator fixed to the rear surface of the external bearing supporter so that the stator is disposed between the outer rotor and the inner rotor, and generating magnetic energy for rotating the double rotor by electrical energy supplied from the outside.

In another aspect of the present invention, provided herein is a driving apparatus for a washing machine comprising a tub containing washing water and provided with a drum rotatably installed therein; a double rotor comprising an outer rotor provided with magnets supported by the inner surface thereof, and an inner rotor installed at the inside of the outer rotor and provided with magnets supported by the outer surface thereof; an internal bearing supporter fixed to the rear surface of the tub, and provided with an internal bearing for rotatably supporting a drum shaft connecting the drum and the double rotor; an external bearing supporter provided with an external bearing for rotatably supporting the outer end of the drum shaft and a plurality of bolt connection holes and positioning holes formed therethrough; and a stator comprising cores, both surfaces of which are respectively opposite to the magnets of the outer rotor and the magnets of the inner rotor, an insulator made of an insulating material and surrounding the outer surfaces of the cores, coils wound on the outer surface of the insulator, a mold portion integrally formed on the outer surfaces of the insulator and the coils by insert molding so that both surfaces of the cores are exposed from the mold portion, and a fixing portion extended from the mold portion, provided with connection holes formed at positions corresponding to the bolt connection holes of the external bearing supporter so that bolts are inserted into the connection holes and the bolt connection holes and positioning protrusions are inserted into the corresponding positioning holes of the external bearing supporter so as to fix the fixing portion to the rear surface of the external bearing supporter.

In another aspect of the present invention, provided herein is a driving apparatus for a washing machine comprising a tub containing washing water and provided with a drum rotatably installed therein; a double rotor comprising an outer rotor provided with magnets supported by the inner surface thereof, and an inner rotor installed at the inside of the outer rotor and provided with magnets supported by the outer surface thereof; an internal bearing supporter fixed to the rear surface of the tub, and provided with an internal bearing for rotatably supporting a drum shaft connecting the drum and the double rotor; an external bearing supporter provided with an external bearing for rotatably supporting the outer end of the drum shaft and a plurality of bolt connection holes and positioning holes formed therethrough; and a stator comprising cores, both surfaces of which are respectively opposite to the magnets of the outer rotor and the magnets of the inner rotor, an insulator surrounding the outer surfaces of the cores, coils wound on the outer surface of the insulator, and a fixing portion extended from the insulator, provided with connection holes formed at positions corresponding to the bolt connection holes of the external bearing supporter so that bolts are inserted into the connection holes and the bolt connection holes and positioning protrusions are inserted into the corresponding positioning holes of the external bearing supporter so as to fix the fixing portion to the rear surface of the external bearing supporter.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a longitudinal sectional view schematically illustrating the structure of a drum washing machine applying a conventional outer rotor-type motor;

FIG. 2 is a longitudinal sectional view illustrating the structure of a driving apparatus for a washing machine, which comprises a double rotor-type motor, in accordance with one embodiment of the present invention;

FIG. 3 is an exploded perspective view of the double rotor-type motor of the drum washing machine of FIG. 2; and

FIG. 4 is a longitudinal sectional view illustrating the structure of a driving apparatus for a washing machine in accordance with another embodiment of the present invention.

### BEST MODE FOR CARRYING OUT THE INVENTION

Reference will now be made in detail to the preferred embodiments of the present invention, examples of which are illustrated in the accompanying drawings.

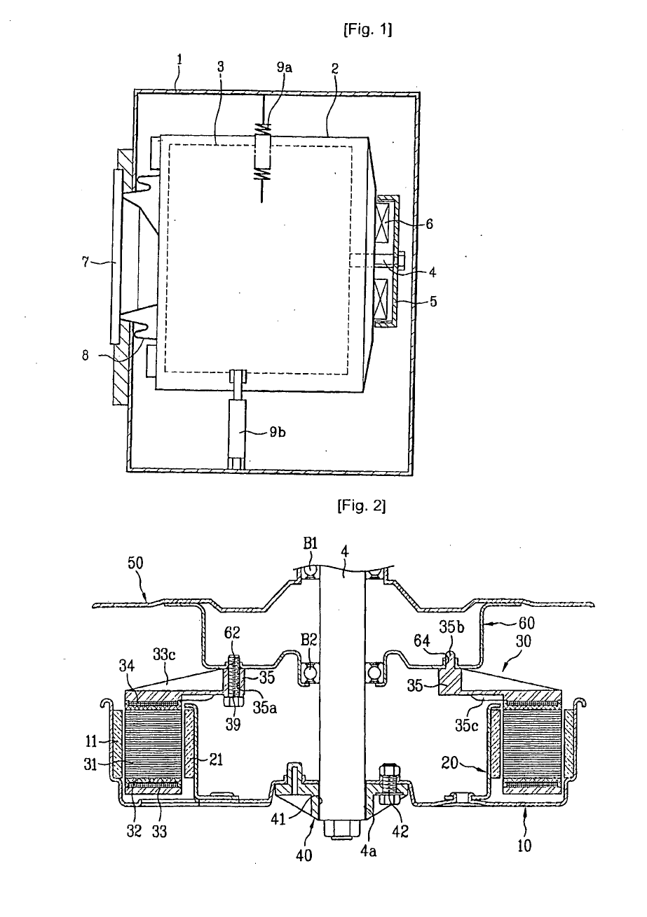

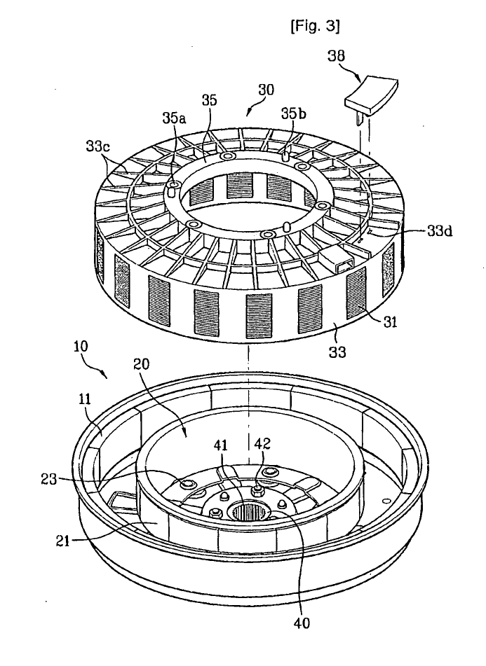

As shown in FIGS. 2 and 3, a drum shaft 4 is installed on the center of the rear portion of the drum (with reference to FIG. 1) and is extended backward. An internal bearing supporter 50, which supports an internal bearing B1 for rotatably supporting the drum shaft 4, is fixedly connected to the rear surface of the tub 2 (with reference to FIG. 1), and an external bearing supporter 60, which rotatably supports the outer end of the drum shaft 4 is connected to the outer surface of the internal bearing supporter 50. Although this embodiment illustrates that the internal bearing B1 is fixed to the central portion of the internal bearing supporter 50 fixed to the rear surface of the tub 2, the internal bearing B1 may be fixed to the central portion of the rear surface of the tub 2 without using the internal bearing supporter 50.

The outer circumferential surface of the external bearing supporter 60 is fixed to the internal bearing supporter 50 by various methods, such as welding, screw-connecting and caulking. The external bearing supporter 60 may be made of various materials. However, preferably, the external bearing supporter 60 is made of metal.

A motor for rotating the drum shaft 4 is installed on the external bearing supporter 60. The motor is a double rotor-type motor comprising an outer rotor 10, an inner rotor 20, and a stator 30. The stator 30 is fixed to the rear surface of the tub 2, and the outer rotor 10 and the inner rotor 20 are respectively spaced from the outer circumferential surface and the inner circumferential surface of the stator 30 by a designated interval.

A bushing 40, to which the drum shaft 4 is fixedly connected, is fixed to the central portion of the outer rotor 10. The bushing 40 is made of insulating resin. The bushing 40 is fixed to the central portion of the outer rotor 10 by connecting units, such as bolts 42. However, the bushing 40 may be formed integrally with the outer rotor 10 by insert molding.

A hole, into which the drum shaft 4 is inserted, is formed through the central portion of the bushing 40, and a serration portion 41, which is engaged with a serration portion 4a formed on the outer circumferential surface of the drum shaft 4, is formed on the inner circumferential surface of the hole.

A plurality of magnets 11 are formed on the inner circumferential surface of the outer rotor 10 such that N and S poles of the magnets 11 are alternated with each other in the circumferential direction. Further, a plurality of magnets 21 are formed on the outer circumferential surface of the inner rotor 20 opposite to the magnets 11 of the outer rotor 10 such that N and S poles of the magnets 21 are alternated with each other in the circumferential direction. Preferably, lower portions of the outer rotor 10 and the inner rotor 20, which contact each other, are fixed by caulking holes 23 obtained by pressing or caulking.

The inner rotor 20 and the outer rotor 10 are made of an injection mold, and are preferably made of metal so as to serves as a back yoke. When the inner rotor 20 and the outer rotor 10 are made of a resin injection mold, a back yoke is additionally attached to the outer surfaces of the magnets 21 and 11 so as to form a magnetic path.

The stator 30 comprises a plurality of split cores 31, an insulator 32 made of insulating resin and surrounding the split cores 31, coils 34 wound on the outer surface of the insulator 32, and a mold portion 33 formed on the outer surfaces of the insulator 32 and the coils 34 by insert molding. When the outer surfaces of the coils 34 are coated with enamel so that the coils 34 are electrically insulated from other parts, the insulator 32 may be omitted.

A fixing portion 35 for fixing the stator 30 to the external bearing supporter 60 is extended radially inwardly from the inner circumferential surface of one end of the mold portion 33 of the stator 30.

Further, the fixing portion 35 may be extended radially outwardly from the mold portion 33 of the stator 30.

Preferably, the fixing portion 35 is formed integrally with the mold portion 33 by insert molding. However, the fixing portion 35 may be formed separately from the mold portion 33 and be fixedly connected to the mold portion 33. In this case, the fixing portion 35 may be made of resin or metal, which is the same as or differs from the material of the mold portion 33.

In order to fix the stator 30 to the external bearing supporter 60, a plurality of bolt connection holes 62, which are separated from each other by a designated interval, are formed through the external bearing supporter 60 in the circumferential direction, and a plurality of connection holes 35a corresponding to the bolt connection holes 62 are formed through the fixing portion 35 of the stator 30.

In order to mount the stator 30 concentrically with the drum shaft 4, a plurality of positioning protrusions 35b for determining the position of the stator 30 fixed to the external bearing supporter 60 are formed on the fixing portion 35 of the stator 30, and a plurality of positioning holes 64, into which the positioning protrusions 35b are inserted, are formed through the external bearing supporter 60.

Accordingly, when the stator 30 is assembled with the external bearing supporter 60, the positioning protrusions 35b of the stator 30 are inserted into the positioning holes 64 of the external bearing supporter 60. Thereby, the position of the stator 30 fixed to the external bearing supporter 60 is determined, and the connection holes 35a of the stator 30 correctly correspond to the bolt connection holes 62 of the external bearing supporter 60.

Preferably, ends of the positioning protrusions 35b have an approximately conical shape so that the ends of the positioning protrusions 35b are easily inserted into the positioning holes 64 of the external bearing supporter 60. Further, preferably, the positioning holes 64 of the external bearing supporter 60 have a shape and a size similar to those of the positioning protrusions 35b so that the positioning protrusions 35b are firmly fitted to the positioning holes 64.

That is, preferably, portions of the positioning holes 64, into which bodies of the positioning protrusions 35b are inserted, have a cylindrical shape with a uniform diameter, and portions of the positioning holes 64, into which the conical ends of the positioning protrusions 35b are inserted, have a conical shape with a decreasing diameter.

On the other hand, positioning holes may be formed through the stator 30, and positioning protrusions or pins may be formed on the external bearing supporter 60.

A reinforcing unit for reinforcing the rigidity of the mold portion 33 is provided on the outer surface of the mold portion 33. Preferably, the reinforcing unit comprises a plurality of reinforcing ribs 33c. Further, preferably, reinforcing ribs 35c are formed at an inner corner of the meeting portion of the mold portion 33 and the fixing portion 35 such that the reinforcing ribs 35c does not interfere the rotation of the inner rotor 20.

In order to reinforce the rigidity of the mold portion 33, instead of the above-described reinforcing ribs 33c and 35c, reinforcing brackets (not shown), each of which has a ring shape and is made of metal, may be respectively attached to the inner and outer surfaces of the fixing portion 35.

A hall sensor 38 for measuring the rotational speed of the double rotor is installed at a designated portion of the stator 30. A sensor terminal of the hall sensor 38 is inserted into a hole 33d formed through the upper surface of the stator 30, and then the hall sensor 38 measures the rotational speed of the double rotor. A connector 37 for supplying power to the coils 34 of the stator 30 is formed on the mold portion 33 at one side of the hall sensor 38.

The above-described motor will be assembled with a washing machine, as below.

First, when the positioning protrusions 35b of the stator 30 are inserted into the positioning holes 64 of the external bearing supporter 60, as described above, the position of the stator 30 fixed to the external bearing supporter 60 is determined and the connection holes 35a of the stator 30 correctly correspond to the bolt connection holes 62 of the external bearing supporter 60.

In this state, the connection holes 35a of the stator 30 and the bolt connection holes 62 of the external bearing supporter 60 are connected by bolts 39 inserted thereinto, thereby firmly fixing the stator 30 to the rear surface of the external bearing supporter 60.

After the stator 30 is fixed to the rear surface of the external bearing supporter 60, the end of the drum shaft 4 is connected to the bushing 40 connected to the outer rotor 10. Thereby, the fixation of the motor to the washing machine is completed.

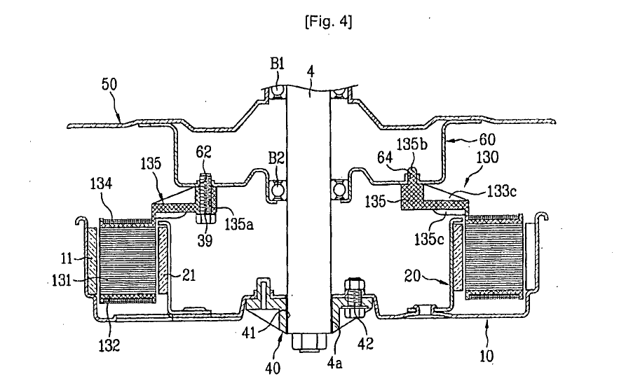

FIG. 4 is a longitudinal sectional view illustrating the structure of a driving apparatus for a washing machine in accordance with another embodiment of the present invention.

As shown in FIG. 4, the basic constitution of the driving apparatus of this embodiment is the same as that of the driving apparatus of the earlier embodiment.

However, the driving apparatus of this embodiment differs from the driving apparatus of the earlier embodiment in that a mold portion is not formed on a stator 130 and a fixing portion 135 is extended directly from an insulator 132 provided on the outer surfaces of cores 131.

That is, as shown in FIG. 4, the fixing portion 135 is extended radially inwardly from one end of the insulator 132 close to the external bearing supporter 60, and connection holes 135a spaced from each other, for connecting the fixing portion 135 to the external bearing supporter 60, and positioning protrusions 135b spaced from each other are formed through and on the fixing portion 135. The fixing portion 135 may be extended radially outwardly from the insulator 132.

Preferably, the fixing portion 135 is formed integrally with the insulator 132. However, the fixing portion 135 having a frame shape made of metal may be formed separately from the insulator 132, and be fixed to the insulator 135.

The fixing method of the fixing portion 135 of the insulator 132 to the external bearing supporter 60 in the driving apparatus of this embodiment is the same as that in the driving apparatus of the earlier embodiment, and a detailed description thereof will thus be omitted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention provides a driving apparatus for rotating a drum of a washing machine.

The driving apparatus of the present invention provides effects, as below.

First, the driving apparatus comprises a stator and inner and outer rotors respectively installed at the inside and the outside of the stator, thereby having drastically increased output without increase in size and volume.

Second, since cores and an insulator of the stator are supported by a mold portion, a fixing portion for fixing the stator to the washing machine is easily formed.

Third, when the mold portion surrounds the outer surfaces of the cores, the insulator, and coils of the stator, the stator has an improved waterproof property. Accordingly, when the driving apparatus is applied to a machine using water, such as a washing machine, the driving apparatus has no opportunity to generate a short circuit of the stator caused by water and improves endurance of the stator.

1. A driving apparatus for a washing machine comprising:
a tub containing washing water and provided with a drum rotatably installed therein;
a double rotor comprising an outer rotor provided with magnets supported by the inner surface thereof, and an inner rotor installed at the inside of the outer rotor and provided with magnets supported by the outer surface thereof;
an internal bearing fixed to the rear surface of the tub for rotatably supporting the inner portion of a drum shaft connecting the drum and the double rotor;
an external bearing supporter provided with an external bearing for rotatably supporting the outer end of the drum shaft; and
a stator fixed to the rear surface of the external bearing supporter so that the stator is disposed between the outer rotor and the inner rotor, and generating magnetic energy for rotating the double rotor by electrical energy supplied from the outside.

2. The driving apparatus as set forth in claim 1, wherein the stator comprises:
cores, both surfaces of which are respectively opposite to the magnets of the outer rotor and the magnets of the inner rotor;
an insulator made of an insulating material and surrounding the outer surfaces of the cores;
coils wound on the outer surface of the insulator;
a mold portion integrally formed on the outer surfaces of the insulator and the coils by insert molding so that both surfaces of the cores are exposed from The mold portion; and
a fixing portion extended from the mold portion and fixed to the rear surface of the external bearing supporter.

3. The driving apparatus as set forth in claim 1, wherein the stator comprises:
cores, both surfaces of which are respectively opposite to the magnets of the outer rotor and the magnets of the inner rotor;
an insulator surrounding the outer surfaces of the cores;
coils wound on the outer surface of the insulator; and
a fixing portion extended from the insulator and fixed to the rear surface of the external bearing supporter.

4. The driving apparatus as set forth in claim 1, further comprising an internal bearing supporter fixedly connected to the rear surface of the tub and provided with the central portion, to which the internal bearing is fixedly connected.

5. The driving apparatus as set forth in claim 1, wherein:
a plurality of bolt connection holes are formed through the external bearing supporter and a plurality of connection holes corresponding to the bolt connection holes are formed through the stator; and
the bolt connection holes and the connection holes are connected by bolts inserted thereinto so that the stator is fixed to the external bearing supporter.

6. The driving apparatus as set forth in claim 1, further comprising a positioning unit for determining the position of the stator fixed to the external bearing supporter in order to concentrically connect the stator to the drum shaft.

7. The driving apparatus as set forth in claim 6, wherein the positioning unit comprises at least one positioning protrusion formed on the stator, and at least one positioning hole formed through the external bearing supporter so that the positioning protrusion is inserted into the positioning hole.

8. The driving apparatus as set forth in claim 6, wherein the positioning unit comprises at least one positioning protrusion formed on the external bearing supporter towards the stator, and at least one positioning hole formed through the stator so that the positioning protrusion is inserted into the positioning hole.

9. The driving apparatus as set forth in claim 1, wherein the external bearing supporter is made of metal.

10. The driving apparatus as set forth in claim 2, wherein a reinforcing unit for reinforcing the rigidity of the mold portion is provided on the mold portion of the stator.

11. The driving apparatus as set forth in claim 10, wherein the reinforcing unit comprises a plurality of reinforcing ribs formed integrally on the outer surface of the mold portion.

12. A driving apparatus for a washing machine comprising:
a tub containing washing water and provided with a drum rotatably installed therein;
a double rotor comprising an outer rotor provided with magnets supported by the inner surface thereof, and an inner rotor installed at the inside of the outer rotor and provided with magnets supported by the outer surface thereof;
an internal bearing supporter fixed to the rear surface of the tub, and provided with an internal bearing for rotatably supporting a drum shaft connecting the drum and the double rotor;
an external bearing supporter provided with an external bearing for rotatably supporting the outer end of the drum shaft and a plurality of bolt connection holes and positioning holes formed therethrough; and
a stator comprising cores, both surfaces of which are respectively opposite to the magnets of the outer rotor and the magnets of the inner rotor, an insulator made of an insulating material and surrounding the outer surfaces of the cores, coils wound on the outer surface of the insulator, a mold portion integrally formed on the outer surfaces of the insulator and the coils by insert molding so that both surfaces of the cores are exposed from the mold portion, and a fixing portion extended from the mold portion, provided with connection holes formed at positions corresponding to the bolt connection holes of the external bearing supporter so that bolts are inserted into the connection holes and the bolt connection holes and positioning protrusions are inserted into the corresponding positioning holes of the external bearing supporter so as to fix the fixing portion to the rear surface of the external bearing supporter.

13. A driving apparatus for a washing machine comprising:
a tub containing washing water and provided with a drum rotatably installed therein;
a double rotor comprising an outer rotor provided with magnets supported by the inner surface thereof, and an inner rotor installed at the inside of the outer rotor and provided with magnets supported by the outer surface thereof;
an internal bearing supporter fixed to the rear surface of the tub, and provided with an internal bearing for rotatably supporting a drum shaft connecting the drum and the double rotor;
an external bearing supporter provided with an external bearing for rotatably supporting the outer end of the drum shaft and a plurality of bolt connection holes and positioning holes formed therethrough; and
a stator comprising cores, both surfaces of which are respectively opposite to the magnets of the outer rotor and the magnets of the inner rotor, an insulator surrounding the outer surfaces of the cores, coils wound on the outer surface of the insulator, and a fixing portion extended from the insulator, provided with connection holes formed at positions corresponding to the bolt connection holes of the external bearing supporter so that bolts are inserted into the connection holes and the bolt connection holes and positioning protrusions are inserted into the corresponding positioning holes of the external bearing supporter so as to fix the fixing portion to the rear surface of the external bearing supporter.
